(19) United States
(12) Patent Application Publication
(10) Pub. No.: US 2012/0229550 A1
(43) Pub. Date: Sep. 13, 2012

(54) PRINTING DEVICE AND METHOD FOR PRINTING A PRINTING SUBSTRATE

(76) Inventors: Stefan Schluenss, Schacht-Audorf (DE); Andreas Mandik, Graf-Spee-Str. (DE); Soenke Dehn, Freidorfer Web (DE)

(21) Appl. No.: 13/392,883

(22) PCT Filed: Aug. 18, 2010
(86) PCT No.: PCT/EP2010/062018

§ 371 Date: May 3, 2012

(30) Foreign Application Priority Data
Aug. 31, 2009 (DE) 102009039444.3

(51) Int. Cl. B41J 29/38

(52) U.S. Cl. 347/16

(57) ABSTRACT

Disclosed herein is a method for printing a printing substrate (6), in which the printing substrate (6) is printed with at least one first printing unit (9) and at least one second printing unit (9), said at least one second printing unit, viewed in a transport direction (A) of the printing substrate, being located downstream of the at least one first printing unit. In this method, a reference image is applied by the at least one first printing unit (9) and a location of the reference image is determined in a direction transverse to the transport direction of the printing substrate (6) in a position that is located, viewed in transport direction of the printing substrate, between the at least one first printing unit (9) and the at least one second printing unit (9). Subsequently, a position of the at least one second printing unit (9) transverse to the transport direction (A) of the printing substrate (6) is adjusted based on the determined location of the reference image in order to align the at least one second printing unit (9) relative to the at least one first printing unit (9) while the printing substrate (6) is being printed. In addition, a printing device (1) for printing a printing substrate (6) is described, said printing device (1) comprising at least one first printing unit (9) and at least one second printing unit (9), the at least one first printing unit (9), viewed in a transport direction (A) of the printing substrate (6), being located upstream of the at least one second printing unit (9). Furthermore, at least one sensor is provided, said sensor being aligned in a prespecified fixed positional relationship with respect to the first printing unit (9) and being directed at a position of a printing substrate path that is located, viewed in transport direction of the printing substrate, between the at least one first printing unit and the at least one second printing unit, and at least one adjustment unit is provided for the adjustment of the at least one second printing unit transverse to the transport direction (A) of the printing substrate (6) based on a signal of the at least one sensor.

### TECHNICAL FIELD OF THE INVENTION

The present invention relates to a printing device and to a method for printing a printing substrate, comprising at least one first printing unit and at least one second printing unit, said at least first printing unit, viewed in a transport direction of the printing substrate, being located upstream of the at least one second printing unit.

### BACKGROUND OF THE INVENTION

In printing technology, in particular in digital printing and, specifically, in ink jet printing it is known to provide a printed image with several printing units that are sequentially arranged in transport direction of a printing substrate. The printing units may, for example, be individual print lines like linear drop generators that, as an assembly, form a printhead. In so doing, the print lines are frequently arranged in groups so that, viewed in transport direction of the printing substrate, the print lines of a first group are upstream of the print lines of a second group. The print lines of the respective groups are then statically adjusted during manufacture in such a manner that they essentially do not overlap in a direction transverse to the transport direction of the printing substrate and make essentially seamless printing possible. For the adjustment, a fixed straight run of the web of printing substrate is assumed with respect to the printhead that is composed of several print lines.

However, the run of the web may be subject to fluctuations, and only finite accuracy can be achieved regarding the control of the run of the web. In addition, the application of a printing ink inside the printhead, for example, may also lead to a transverse movement of the web, which movement—as a rule—cannot be adjusted by a controller located upstream of the printhead. For example, such a situation occurs in particular when a large amount of printing ink is applied to one side of the printing substrate.

Of course, the same problems also occur with print lines of separate printheads that are intended to print in a register-perfect manner on a printed image of a previous printhead such as is the case, for example, in multi-color printing.

### SUMMARY OF THE INVENTION

The object of the invention is to reduce printing errors that result from an erroneous alignment of at least one first printing unit relative to at least one second printing unit due to transverse movements of a printing substrate during the printing operation.

In accordance with the invention, this object is achieved with a method in accordance with claim 1 and with a printing device in accordance with claim 18. Additional embodiments of the invention are obvious from the subclaims.

In particular, a method is provided for printing a printing substrate with at least one first printing unit and at least one second printing unit, said at least one first printing unit, viewed in a transport direction of the printing substrate, being located upstream of the at least one second printing unit. In this method, a reference image is first applied to the printing substrate by the at least one first printing unit. Subsequently, a location of the reference image is determined in a direction transverse to the transport direction of the printing substrate at a point that is located, viewed in transport direction of the printing substrate, between the at least one first printing unit and the at least one second printing unit. Subsequently, a position of the at least one second printing unit, transverse to the transport direction of the printing substrate, is adjusted based on the determined location of the reference image in order to align the at least one second printing unit relative to the at least one first printing unit while the printing substrate is being printed. The transport direction referred to above is a desired transport direction that defines a prespecified, preferably straight, run.

The method in accordance with the invention allows the reduction of potential printing errors that may result from transverse movements of the printing substrate between the first and the second printing units in that the at least one second printing unit is moved laterally.

In a first embodiment of the invention, the at least one first printing unit and the at least one second printing unit print the same color of a monochromatic or polychromatic printed image. Consequently, this method is specifically suitable for multi-line printheads. In this method, the at least one first printhead and the at least one second printhead, respectively, preferably print one strip region of the printed image, these strip regions extending in a direction transverse to the transport direction of the printing substrate and being essentially seamlessly positioned adjacent to each other. The term “essentially seamlessly” is to comprise, in particular, overlaps of the respective strip regions or gaps of at most 15 μm, preferably at most 7 μm, between said strip regions.

In order to initialize the method, the at least one second printing unit is preferably adjusted in such a manner before the start of the process that said printing unit does essentially not overlap the at least one first printing unit in a direction transverse to the transport direction of the printing substrate.

In an alternative embodiment of the invention, the at least one first printing unit and the at least one second printing unit print different colors of a multi-color printed image, so that the method may also be used for different printheads of a multi-color printer. In this case, the at least one first printing unit and the at least one second printing unit, respectively, print areas of the printing image overlapping in a direction transverse to the transport direction, and an adjustment of the at least one second printing unit results in a register-perfect print of the printed image.

In a further embodiment of the invention, the printing substrate is printed with at least one third printing unit that is positioned, viewed in transport direction of the printing substrate, downstream of the at least one second printing unit, and the at least one third printing unit is adjusted in a direction transverse to the printing substrate based on the determined position of the reference image. This means that the reference image can be advantageously used for the adjustment of several printing units that, viewed in transport direction of the printing substrate, are sequentially arranged in order to allow both the adjustment of printing units within a single printhead and the adjustment of printing units of different printheads. It is possible to adjust the third printing unit in view of the previously determined position of the reference image, alternatively it is possible—for increased accuracy—to determine a position of the reference image transverse to the transport direction of the printing substrate at a point that is located, viewed in transport direction of the printing substrate, between the at least one second printing unit and the at least one third printing unit and to adjust the third printing unit by means of the determined position of the reference image.

Preferably, the at least one printing unit is adjusted within a range of ±100 μm and, in particular, within a range of ±50 μm relative to a starting position. This provides enough of an adjustment range to compensate for commonly occurring fluctuations while the printing substrate is being advanced, and, on the other hand, the range is small enough so that the adjustments can be performed with sufficient speed. In so doing, the position of the at least one second printing unit is adjusted piezoelectrically, because piezoelectric actuators are able to provide high accuracy within the adjustment range and sufficiently high speed.

The method in accordance with the invention is particularly suitable for printing a printing substrate web. Preferably, each of the printing units is of the ink jet type, said printing units being able to provide good printing quality even at high speeds of the printing substrate. The printing units are preferably printhead lines extending transversely with respect to transport direction. In one embodiment, a plurality of first printhead lines form a group of first printing units, and a plurality of second printhead lines form a group of second printing units. The printhead lines of the respective groups may be arranged offset with respect to each other in a direction transverse to the transport direction of the printing substrate.

In a preferred embodiment of the invention, the reference image is preferably printed outside the actual printed image in order not to impair said printed image. In addition, this facilitates a detection of the reference image.

In one embodiment of the invention, the reference image is a continuous line that preferably has a width of several pixels. As a result of this, a simple and continuous detection of an advance direction of the printing substrate is possible in a simple manner.

The object of the invention herein is also achieved with a printing device for printing a printing substrate, said printing device comprising at least one first printing unit and at least one second printing unit, the at least one first printing unit, viewed in transport direction of the printing substrate, being located upstream of the at least one second printing unit. The printing device comprises at least one sensor, said sensor being aligned in a prespecified fixed positional relationship with respect to the first printing unit and being directed at a position of a printing substrate path that is located, viewed in transport direction of the printing substrate, between the at least one first printing unit and the at least one second printing unit. Furthermore, at least one adjustment unit is provided for the adjustment of the at least one second printing unit transverse to the transport direction of the printing substrate based on a signal of the at least one sensor. A printing device of the above type makes possible the advantages of an alignment of the printing units relative to each other, said advantages having already been previously explained with reference to the method, by taking into consideration dynamic transverse movements of the printing substrate between the respective printing units.

In one embodiment of the invention, the at least one first printing unit and the at least one second printing unit form a printhead and communicate with a shared toner and ink supply. Due to this, an alignment of printing units within a printhead is made possible. In this case, the at least one second printing unit is dimensioned and adjustable by means of the adjustment unit in such a manner that said second printing unit does not overlap the at least one first printing unit in a direction transverse to the transport direction of the printing substrate and can print in an essentially seamless manner relative to a printing image of the at least one first printing unit. As a result of this, the respective printing units can print strips of a printing image essentially seamlessly, i.e., without substantial overlaps or gaps in between.

In an alternative embodiment, the at least one first printing unit and the at least one second printing unit communicate with different toner or ink supplies, this—as a rule—being the case with different printheads. In this case, the first printing unit and the at least on second printing unit extend essentially across the same width in a direction transverse to the transport direction of the printing substrate in order to be able to produce different colors of a multi-color print on top of each other. The adjustment of the second printing unit enables register-perfect printing of the respective color separation images.

In another embodiment of the invention, at least one third printing unit is provided, said third printing unit being positioned, viewed in transport direction of the printing substrate, downstream of the second printing unit, and at least one adjustment unit is provided for adjusting the at least one third printing unit in a direction transverse with respect to the advance direction of the printing substrate with the use of a signal of at least one sensor, said sensor being directed at a position of the printing substrate path that is located, viewed in transport direction of the printing substrate, between the at least one first printing unit and the at least one third printing unit. This enables the adjustment of printing units within a printhead, as well as the alignment of separate printheads relative to each other, based on a reference image that has been applied by the first printing unit and can be detected by the sensor.

In this embodiment, it is possible to use the signal of the sensor that is directed at the printing substrate path between the at least one first printing unit and the at least one second printing unit, or it is possible to provide an additional sensor that is directed at a position of the printing substrate path that, viewed in transport direction of the printing substrate, is located between the at least one second printing unit and the at least one third printing unit. In the last-mentioned case, the accuracy of the positional adjustment of the at least one third printing unit is increased again because a transverse movement of the printing substrate along the printing substrate path may change.

Preferably, the at least one adjustment unit features an adjustment range of ±100 μm, and, in particular, an adjustment range of ±50 μm, relative to a zero position, said zero position relating to an adjustment of the printing units relative to each other with an exact, straight movement of the printing substrate.

In order to provide rapid response times for the adjustment of the at least one second printing unit and/or the at least one third printing unit, the at least one adjustment unit comprises a piezo actuator.

Preferably, the printing units are of the ink jet type, these providing good printing quality at high printing substrate speeds. In one embodiment, the printing units are printhead lines arranged in a direction transverse to the transport direction of the printing substrate. In particular, a plurality of first printhead lines form a group of first printing units, and a plurality of second printhead lines form a group of second printing units. The printhead lines of the respective groups may be arranged so as to be offset relative to each other in a direction transverse to the transport direction of the printing substrate.

Furthermore, a printer is provided, said printer comprising at least one printing device of the aforementioned type and one conveyor device for conveying a printing substrate web along the at least one printing device. The printer preferably comprises a plurality of printing devices of the above type, said printing devices enabling an adjustment of printing units within a printhead and/or adjustments of printing units of different printheads relative to each other.

### BRIEF DESCRIPTION OF THE DRAWINGS

Hereinafter, the invention will be described in detail with reference to the drawings. They show in

FIG. 1 a schematic side view of a printing machine for web printing;

FIG. 2 a schematic view, from the bottom, of the printheads of the printing machine in accordance with FIG. 1;

FIG. 3 a schematic detailed view of a printhead and the positioning of image dots of individual print lines of the printhead when a printing substrate is being printed, said printing substrate being correctly moved past the printhead;

FIG. 4 a schematic view similar to FIG. 3, wherein the printing substrate is moved incorrectly, i.e., in a skewed manner, past the print head.

### DETAILED DESCRIPTION OF THE INVENTION

Information regarding location or direction used in the description hereinafter relates primarily to the representation in the drawing and is thus not to be viewed as being restrictive. However, said information may also relate to a preferred final arrangement.

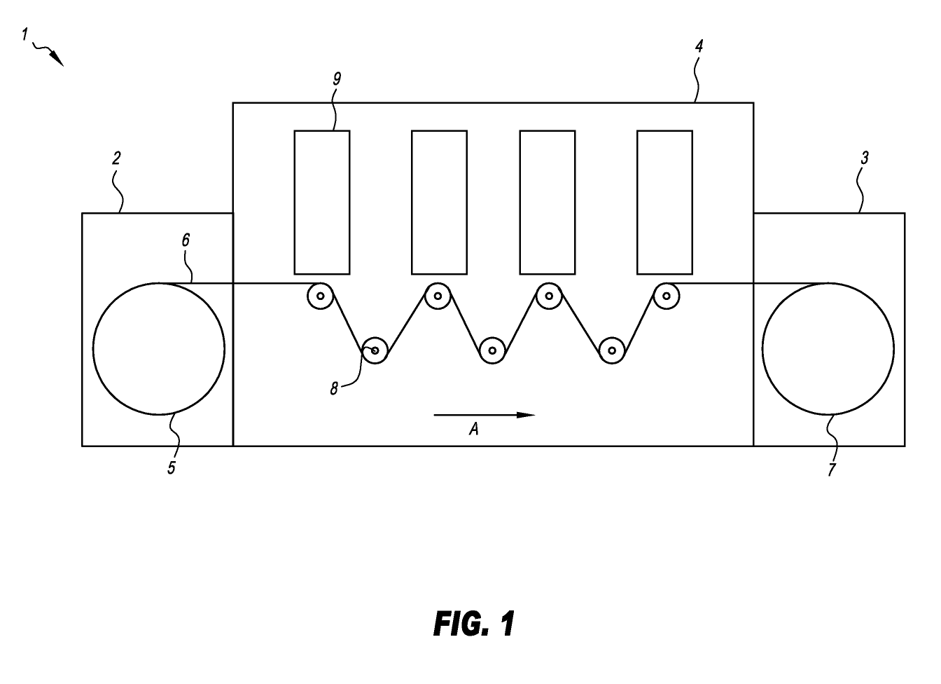

FIG. 1 is a schematic side view of a printing machine 1 without a lateral frame in order to clear the view into the inside of the printing machine 1. The printing machine 1 comprises a feeder 2, an output region 3, as well as a printing region 4 located in between. A printing substrate roll 5 is rotatably supported in the feeder 2, a printing substrate web 6 being guided from said roll through the printing region 4 to a printing substrate take-up roll 7 in the output region 3. During a printing operation, the printing substrate web 6 is conveyed from the printing substrate roll 5 to the printing substrate take-up roll 7, i.e., via a plurality of transport rollers 8 in the printing region, only a few of said transport rollers being shown in order to simplify the illustration.

The printing region 4 of the printing machine 1 comprises a plurality of printing units 9 as well as the plurality of transport rollers 8. Only seven of the transport rollers 8 are schematically shown in FIG. 1; however, as a rule, a larger number is provided, said transport rollers conveying the printing substrate web 6 along a non-linear transport path through the printing region 4. Upstream of the first printing unit 9, viewed in a transport direction A of the printing substrate web 9 as indicated by an arrow, it is possible to provide an alignment unit in order to set a movement of the printing substrate web 6 through the printing machine 1 as to be straight.

FIG. 1 shows four printing units 9, so that the printing machine 1 would be suitable for four-color printing. However, depending on use, it is also possible to provide a number of printing units 9 different there from. The printing units 9 are ink jet printing units that will be described in greater detail hereinafter; however, they may also be of another type.

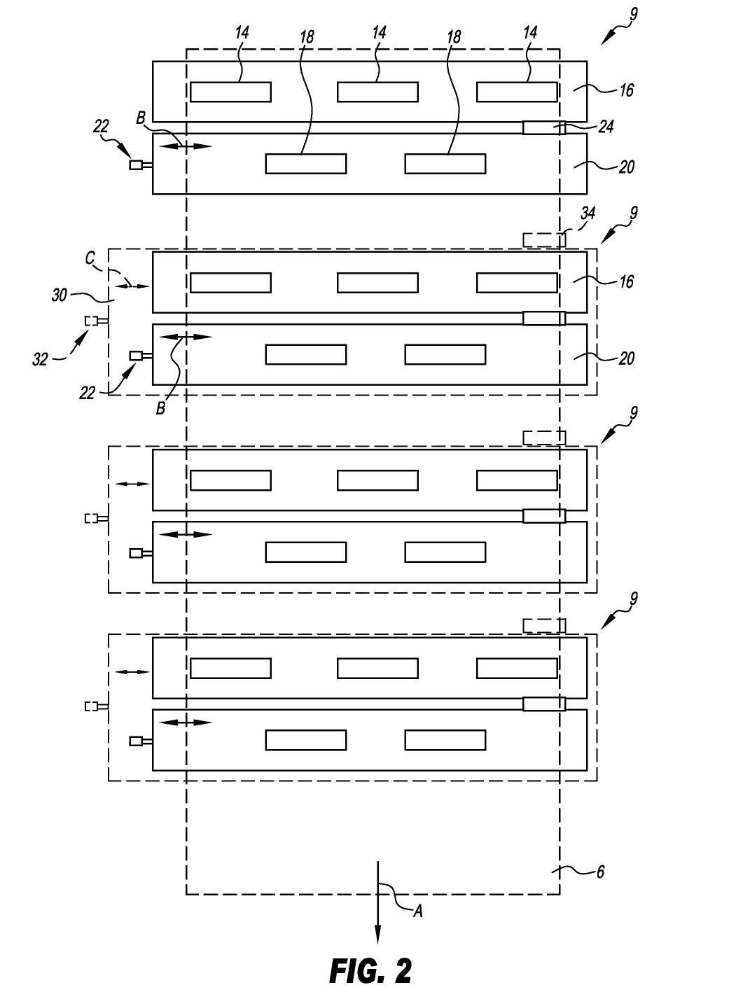

FIG. 2 is a schematic view, from the bottom, of the printing units 9. Furthermore, FIG. 2 shows a printing substrate web in dashed lines. A transport direction A of the printing substrate 6 along the printheads 9 is indicated by an appropriate arrow. The indicated transport direction A denotes an ideal moving direction of the printing substrate web 6. However, the actual moving direction may deviate therefrom, as will be explained in greater detail hereinafter.

The printing units 9 are essentially designed in the same manner, each comprising a first group of printhead lines 14 that are affixed to a common carrier element 16, as well as a second group of printhead lines 18 that are affixed to a second common carrier element 20. Furthermore, an adjustment element 22 as well as a sensor element 24 are provided.

Each of the printhead lines 14 of the first group is aligned perpendicular to transport direction A of the printing substrate 6 and comprises, in a manner known per se, dot nozzles for the selective ejection of an ink jet. Such printhead lines are known in the art and will thus not be explained in greater detail. The printhead lines 14 are affixed to the carrier element 16 in such a manner that they are at a distance from each other in a direction transverse to transport direction A of the printing substrate web 6 and are located on a line. The distance between the printhead lines 14 is selected in such a manner that it corresponds to the length of a printhead line 18. FIG. 2 shows three printhead lines 14, although it is obvious to the person skilled in the art that it is also possible to provide a number different there from. It would even be possible to provide only one printhead line 14 on the carrier element 16. The carrier element 16 is immovably affixed to the printhead 9.

The printhead lines 18 are of the same type as the printhead lines 14 and are also arranged so as to extend perpendicularly with respect to transport direction A of the printing substrate web 6. The printhead lines 18 are arranged on the carrier element 20 so as to be perpendicular to transport direction A on a line and at a distance with respect to each other. The distance between the printhead lines 18 corresponds to the length of the printhead lines 14. FIG. 2 shows two printhead lines 18, although it is obvious to the person skilled in the art that it is also possible to provide a number different there from. It would even be possible to provide only one printhead line 18 on the carrier element 20. The printhead lines 14 are arranged offset with respect to the printhead lines 18 in a direction transverse to transport direction A, as will still be explained in greater detail hereinafter.

The carrier element 20 is supported so as to be shiftable in a direction perpendicular to transport direction A inside the printing unit 9, as is indicated by double arrow B in FIG. 2. A corresponding shift of the carrier element 20 can be accomplished by means of the adjustment unit 22, said adjustment unit comprising, for example, a piezo actuator. The adjustment range of the adjustment unit 22 is preferably in a range of ±100 μm, starting from a zero position, and, in particular, within a range of ±50 μm, starting from the zero position. The zero position, or also reference position, defines a relative alignment of the printhead lines 14, 18 for an ideal advance direction of the printing substrate web 6.

Viewed in transport direction A, a sensor 24 is provided between the first group of printhead lines 14 and the second group of printhead lines 18, said sensor being directed at an edge region of the printing substrate web 6. The sensor 24 is arranged in a fixed positional relationship with the right outer printhead line 14 in FIG. 2 and may be permanently affixed to the carrier element 16, for example. The sensor element 24 is arranged in such a manner that it at least partially overlaps the right outer printhead line 14 of the first group in a direction transverse to transport direction A. The sensor 24 is of a type that is suitable for detecting a position of a reference image generated by the right outer printhead line 14 in a direction transverse to transport direction A of the printing substrate web 6. To do so, it is possible to use a CCD line or an analog position sensor. By way of such a position detection of a reference image, it is possible to determine a movement of the printing substrate web 6 deviating from transport direction A, where transport direction A is always assumed to be an optimal advance direction of the printing substrate web 6 extending perpendicularly to the respective printhead lines.

As will be explained in greater detail hereinafter, the printing unit 9 comprises a suitable, not illustrated, control unit in order to process the signals of the sensor 24 relating to the position of a reference image and use said signals to enable the adjustment unit 22.

As previously mentioned, each of the printing units may be designed equally as in the above-described manner. However, it is also possible that the second, third and fourth printing units, said units being sequentially arranged viewed in transport direction A, optionally comprise elements in addition to those that have been described above. Such optional elements are shown in dashed lines in FIG. 2 and will be explained hereinafter. The optional elements are a carrier element 30, an adjustment element 32 and a sensor 34.

In the second through fourth printing units 9, said units being sequentially arranged viewed in transport direction A, both the first carrier element 16 and the second carrier element 20 are affixed together to the carrier element 30. The carrier element 20 can be shifted relative to the carrier element 30 in a direction transverse to transport direction A, as indicated by double arrow B, whereas the first carrier element 16 is permanently affixed thereto. The adjustment element 22 is permanently affixed to the carrier element 30.

By means of the adjustment element 32, the carrier element 30 can be shifted in a direction transverse to transport direction A of the printing substrate web 6, as is indicated by double arrow C. Like the adjustment element 22, the adjustment element 32 may also comprise a piezo actuator featuring a similar adjustment range. Viewed in transport direction A, the sensor 34 is directed at an edge region of the printing substrate web 6 between two successive printing units 9. The sensor 34 is in a fixed positional relationship relative to the right outer printhead line 14 of the first printing unit 9 and cannot be shifted with the carrier element 30. Alternatively, however, said sensor could be shifted with the carrier element. The sensor 34 makes it possible to detect, in a direction transverse to transport direction A of the printing substrate web 6, a position of a reference image that has been generated by this printhead line 14. A not illustrated control unit may activate the adjustment elements 32 and/or 22 based on the thusly determined position in order to shift the carrier elements 30 and/or 20.

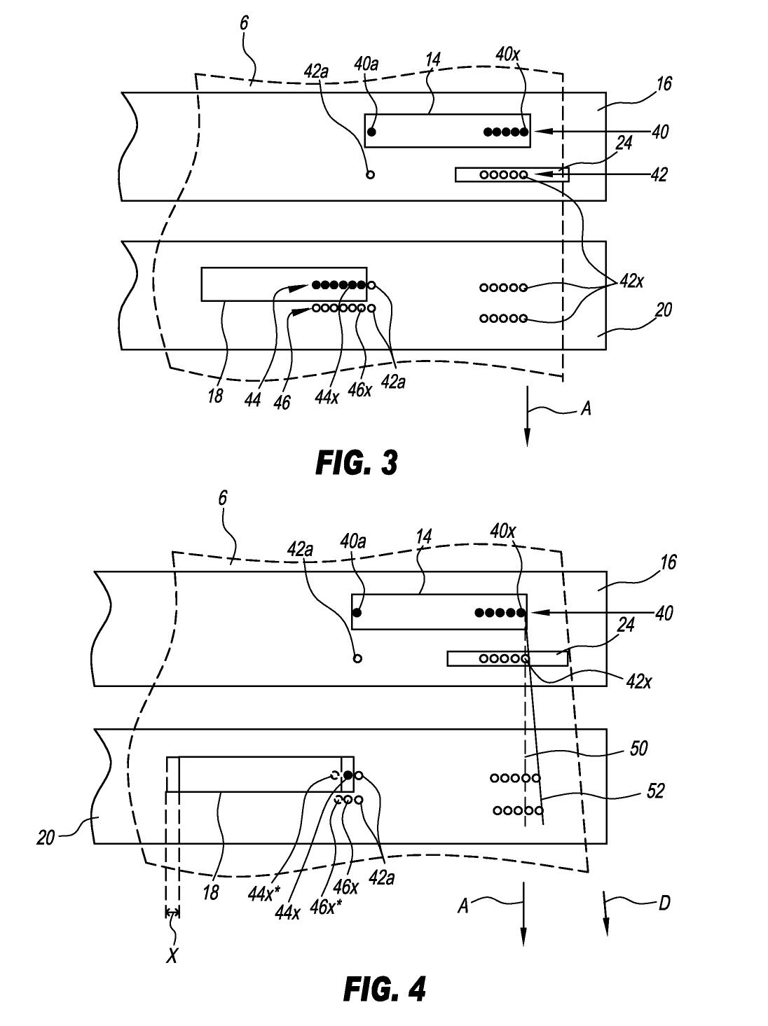

FIG. 3 is a detailed schematic view of an edge region of a printing unit 9. This detailed view shows the right outer printhead line 14 of the first group, the carrier element 16, the right outer printhead line 18 of the second group, the carrier element 20, as well as the sensor 24. In addition, an edge region of a printing substrate web 6 is schematically indicated by a dashed line, said printing substrate web being guided past the printing unit 9 in correct moving direction along transport direction A. The second carrier element 20 is in a zero position, i.e., a position intended for an accurate advance direction of the printing substrate web 6 corresponding to transport direction A.

FIG. 3 shows a few ink jet nozzles 40 of the printhead line 14, said nozzles being indicated by filled circles. In particular, the outermost ink jet nozzles 40 are shown. The ink jet nozzle that is the farthest on the inside is marked 40a, the ink jet nozzle located the farthest on the outside is marked 40x. Each of the ink jet nozzles 40 is able to generate image dots 42 (also referred to as pixels) on the printing substrate web 6, said image dots being represented by unfilled circles in FIG. 3. The ink jet nozzle 40a located the farthest on the inside generates an image dot 42a, and the ink jet nozzle 40x located the farthest on the outside generates an image dot 42x. The respective images dots 42 are depicted in different positions along transport direction A.

FIG. 3 shows a few ink jet nozzles 44 of the printhead line 18, said nozzles being indicated by filled circles. In particular, the ink jet nozzle located the farthest on the outside is marked 44x. Each of the ink jet nozzles 44 is able to generate image dots 46 on the printing substrate web 6, said image dots being represented by unfilled circles in FIG. 3. The ink jet nozzle 44x located the farthest on the outside generates an image dot 46x.

As shown in FIG. 3, the printhead line 14 and the printhead line 18 are aligned relative to each other in such a manner that an image dot 42a can be printed essentially seamlessly adjacent to an image dot 46x when the printing substrate web moves accurately in transport direction A.

FIG. 4 is another schematic detailed view of an edge region of a printing unit 9, similar as in FIG. 3. This detailed view again shows the right outer printhead line 14 of the first group, the carrier element 16, the right outer printhead line 18 of the second group, the carrier element 20, as well as the sensor 24. In addition, an edge region of a printing substrate web 6 is indicated schematically by a dashed line. In contrast with FIG. 3, however, the printing substrate web 6 does not move in a correct moving direction along transport direction A past the printing unit 9. Rather, the moving direction as indicated by arrow D deviates from transport direction A. The second carrier element 20 and thus the printhead line 18 are laterally shifted by a distance X relative to the zero position shown in FIG. 3. This is clearly obvious from the dashed illustration of the printhead line 18 in its zero position.

FIG. 4, again, shows some of the ink jet nozzles 40 of the printhead line 14, said nozzles being represented by filled circles. In particular, the outermost ink jet nozzles 40 are also shown here. The ink jet nozzle located the farthest on the inside is marked 40a, and the ink jet nozzle located the farthest on the outside is marked 40x. The ink jet nozzles 40 are able to generate image dots 42 on the printing substrate web 6, these being indicated by circles that are not filled in FIG. 4. The ink jet nozzle 40a located the farthest on the inside generates an image dot 42a, and the ink jet nozzle 40x located the farthest on the outside generates an image dot 42x. The respective image dots 42 are shown in different positions on the printing substrate web along moving direction D.

FIG. 4 also shows an ink jet nozzle 44x of the printhead line 18, i.e., the ink jet nozzle located the farthest on the outside. The ink jet nozzle 44x is able to generate an image dot 46x on the printing substrate web 6, said image dot being represented by a not filled circle in FIG. 4.

For comparison, FIG. 4 also shows—in dashed lines—the ink jet nozzle 44x* in a zero position of the printhead line 18, as well as an image dot 46x* generated thereby.

As shown in FIG. 4, the printhead line 14 and the printhead line 18 are aligned relative to each other in such a manner to enable printing of an image dot 42a in an essentially seamless manner adjacent to image dot 46x when the printing substrate web moves in moving direction D, this being accomplished by way of shifting the second carrier element 20. Without such shifting, a gap would result between the image dot 42a and the image dot 46*, which gap would cause an error in a printed image.

Now the operation of the printing machine 1 will be described in greater detail with reference to the figures. The printing substrate web 6 is advanced—in a manner known per se—through the printing region 4 of the printing machine 1. The printing units 9 are activated in a manner known per se in order to generate a printed image on the printing substrate web 6. The second carrier elements 20 and the optional carrier elements 30 are each in a zero position.

The printhead line 14 located on the right outside, said printhead being the first in transport direction A, is activated in order to print a reference image, for example, in the form of a continuous strip having the width of several image dots 42, on the printing substrate web 6. Of course, it is also possible for the reference image to have another form, as the person skilled in the art will recognize. The reference image is printed outside the actual printing image in the edge region of the printing substrate web 6.

Due to the movement of the printing substrate web, the strip is moved past the sensor 24, said sensor detecting the position of the strip in a direction transverse to transport direction A. If the printing substrate web 6 is accurately moving in transport direction A, as shown in FIG. 3, the strip is in a desired position and no additional measures are necessary to ensure correct, i.e., essentially seamless printing by the respective printing lines 14, 18.

The strip is also being moved past the sensor 34 of the subsequent printing units 9, said sensor again detecting the position of the strip in a direction transverse to transport direction A. If the printing substrate web 6 is accurately moving in transport direction A, the strip is in a desired position, and no additional measures are necessary to ensure correct, i.e., register-perfect printing by the respective printing units 9.

The printhead line 14—which is always located on the right outside—of each printhead can be activated in such a manner that said printhead line generates a suitable reference image that can be detected by the respective sensor 24. As a result of this, it is possible to determine a correct advance direction of the printing substrate web 6 inside the printhead 9. However, such a determination is also possible with the use of an appropriate detection of the strip generated by the first printhead 9, if said strip is detected by the sensor 34 as well as by the sensor 24, and the relative position of both sensors is known.

Hereinafter, the operation of the printing machine 1 will be explained for the case that the printing substrate web 6 does not move correctly along transport direction A but along a moving direction D, as shown in FIG. 4. In this case, the sensor 24 of the first printhead 9 would detect that the strip is not in the desired position but is deviating there from. To demonstrate this, FIG. 4 shows the desired position of the outside edge of the image dot 42x by dashed line 50, whereas the actual position of the strip is indicated by a solid line 52. The sensor detects the actual position of the strip and sends a corresponding signal to a not illustrated control unit, said control unit determining a deviation from the desired position in the region of the sensor and computing there from an expected deviation in the region of the printhead line 18.

The control unit now activates the adjustment unit 22 in order to laterally shift the second carrier element 20 and thus the printhead lines 18 over a distance X corresponding to the expected deviation, as is shown by FIG. 4. As a result of this, it becomes again possible that the image dots 46x and 42a can essentially be seamlessly printed next to each other, as is shown by FIG. 4. The control unit is, thus, able to detect dynamic changes of the advance direction of a printing substrate and align the printhead lines 14 and 18 relative to each other in order to enable essentially seamless printing.

In addition, a deviation of the strip relative to the desired position would also be detected on the respective sensor 34 of the second through the fourth printing units 9, and a corresponding signal would be output to a control unit of the respective printing unit 9. Now, this control unit determines a deviation from the desired position in the region of the sensor 34 and determines there from an expected deviation in the region of the corresponding printhead line 14. Responding thereto, said control unit activates the adjustment unit in order to laterally shift the carrier element 30 and thus the carrier elements 16, 20 with the printhead lines 14, 18 consistent with the expected deviation. As a result of this, a register-perfect print is made possible between the printing units 9, even if the printing substrate web 6 does not move correctly along transport direction A.

Again, a deviation of the strip from the desired position can be detected at the respective sensors 24 of the second through the fourth printing units 9, said deviation being suitably evaluated in order to cause a shift of the respective second carrier element.

In the above description, it was assumed that each printing unit has its own control unit that controls the shifting of the carrier elements 30 and/or 20. Of course, it is also possible to provide one common control unit for the printing units 9, said control unit controlling the shifting of the carrier elements 30 and/or 20. In addition, it was assumed that the first printing unit 9 generates a reference image. However, it is also possible to generate and evaluate such reference images in each of the printing units 9. It is also possible that the second through fourth printing units are not allotted a sensor 24, and shifting of the carrier elements 30 and 20 occurs on the basis of a sensor signal of the sensor 34. It is also conceivable to completely dispense with the sensors 24 and not provide any adjustment options within a printing unit 9 but only between the printing units 9.

The invention was described with reference to specific embodiments, without being restricted to said specific embodiments. In particular, it is possible, of course, that guiding of the printing substrate web deviates from the illustrated form and the design of the printing units may also be different. Numerous modifications will be obvious to the person skilled in the art, said modifications being covered by the scope of the claims hereinafter.

1. Method for printing a monochromatic or polychromatic printed image on a printing substrate, in which the printing substrate is printed with a first printing unit and a second printing unit, the second printing unit, viewed in a transport direction of the printing substrate, being located downstream of the first printing unit, the method comprising:
applying a reference image using the at least one first printing unit;
determining a location of the reference image in a direction transverse to the transport direction of the printing substrate in a position that is located, viewed in transport direction of the printing substrate, between the first printing unit and the second printing unit; and
adjusting a position of the second printing unit transverse to the transport direction of the printing substrate based on the determined location of the reference image in order to align the at least one second printing unit relative to the determined location of the reference image applied by the at least one first printing unit while the printing substrate is being printed; wherein
the first printing unit and the second printing unit print the same color of the monochromatic or polychromatic printed image, and
the first printing unit and the second printing unit print respective strip regions of the printed image, the strip regions extending in a direction transverse to the transport direction of the printing substrate and being positioned essentially seamlessly next to each other.

2-3. (canceled)

4. The method according to claim 3, wherein the position of the at least one second printing unit is adjusted before the start of the process in such a manner that the printing unit does essentially not overlap the at least one first printing unit in a direction transverse to the transport direction of the printing substrate.

5-6. (canceled)

7. The method according to claim 1, wherein the printing substrate is printed with a third printing unit that is positioned downstream of the second printing unit, and the position of the third printing unit is adjusted based on the determined location of the reference image in a direction transverse to the transport direction of the printing substrate.

8. (canceled)

9. The method according to claim 7, further including determining a location of the reference image in a direction transverse to a transport direction of the printing substrate at a position located, viewed in transport direction of the printing substrate, between the second printing unit and the third printing unit, and adjusting the position of the third printing unit based on the determined second location.

10. The method according to claim 7, wherein the position of the at least one second printing unit or the at least one third printing unit is adjusted within a range of ±100 μm relative to a respective reference position thereof.

11. The method according to claim 1, wherein the position of the second printing unit is adjusted piezoelectrically.

12. The method according to claim 1, wherein the printing substrate is a printing substrate web.

13. The method according to claim 1, wherein each of the printing units is of the ink jet type.

14. The method according to claim 1, wherein the printing units are printhead lines extending in a direction transverse to the transport direction.

15. The method according to claim 1, wherein the reference image is printed outside the monochromatic or polychromatic printed image.

16. The method according to claim 1, wherein the reference image is a continuous line.

17. The method according to claim 16, wherein the line has a width of several pixels.

18. Printing device for printing a printing substrate, the printing device comprising the following:
a first printing unit operative to apply a reference image to the printing substrate;
a second printing unit located downstream of the first printing unit;
a sensor operative to detect the position of the reference image on the printing substrate, the sensor being aligned in a prespecified fixed positional relationship with respect to the first printing unit and being directed at a position of a printing substrate path that is located, viewed in transport direction of the printing substrate, between the at least one first printing unit and the at least one second printing unit; and
an adjustment unit for the adjustment of the at least one second printing unit transverse to the transport direction of the printing substrate based on a signal of the at least one sensor; wherein
the first printing unit and the second printing unit form a printhead and communicate with a shared toner and ink supply, and
the second printing unit is dimensioned and adjustable by means of an adjustment unit so that the second printing unit does not overlap the at least one first printing unit in a direction transverse to the transport direction of the printing substrate and can print in an essentially seamless manner relative to a printing image of the at least one first printing unit.

19-22. (canceled)

23. The printing device according to claim 18, further including:
a third printing unit positioned downstream of the second printing unit;
a second sensor located between the second printing unit and the third printing unit, the second sensor directed at a position of the printing substrate path,
a second adjustment unit positioned between the first printing unit and the third printing unit and adapted to adjust the position of the third printing unit in a direction transverse to the transport direction of the printing substrate in response to the second sensor.

24. (canceled)

25. The printing device according to claim 18 one of the previous claims, wherein the adjustment unit features an adjustment range of ±100 μm and, in particular, an adjustment range of ±50 μm, relative to a reference position.

26. The printing device according to claim 18, wherein the at least one adjustment unit comprises a piezo actuator.

27. The printing device according to claim 18, wherein each of the printing units is of the ink jet type.

28. The printing device according to claim 18, wherein the printing units are printhead lines extending in a direction transverse to the transport direction.

29-30. (canceled)

31. The printing device according to claim 18, further including a conveyor device for conveying a printing substrate web along the at least one printing device.
